(19) United States
(12) Patent Application Publication
(10) Pub. No.: US 2025/0225493 A1
(43) Pub. Date: Jul. 10, 2025

(54) SYSTEM FOR CUSTOMIZED AI COMPOSITION CREATION PLATFORM AND THE OPERATING METHOD OF MURATOR DEVICE

(71) Applicant: Hansung University Industry-University Cooperation Foundation, Seoul (KR)

(72) Inventors: Sung Hoon JUNG, Seoul (KR); Dong Hyeok PARK, Seoul (KR); Chan hee HAN, Seoul (KR)

(73) Assignee: Hansung University Industry-University Cooperation Foundation, Seoul (KR)

(21) Appl. No.: 19/009,438

(22) Filed: Jan. 3, 2025

(30) Foreign Application Priority Data
Jan. 5, 2024 (KR) 10-2024-0002154

(51) Int. Cl. G06Q 20/12; G10H 1/00

(52) U.S. Cl. CPC G06Q 20/123; G10H 1/0025; G10H 2240/181; G10H 2250/005

(57) ABSTRACT

The present invention provides a system for a customized AI composition platform and an operating method of a music curator device. The system comprises a music curator device training deep learning models to generate songs and a platform server providing comprehensive services by providing learning data and deep learning models for automatic composition and collecting trained deep learning models and/or generated song data from at least one or more music curator device, wherein the music curator device transmits a deep learning model trained by a music curator or song data generated by the trained deep learning model to an open market platform.

### TECHNICAL FIELD

The present invention relates to a system for a customized AI composition platform and an operating method of a music curator device, and more specifically, to a one-stop customized AI composition service where a music curator directly purchases deep learning models and learning data for song learning, trains the deep learning models, and generates and sells song data through the trained deep learning models.

### BACKGROUND ART

Recently, with the development of internet networks and the growth of the digital music market, the streaming market, where users enjoy streaming music of various genres, is growing.

In line with the streaming market, research on automatically generating songs with deep learning is actively being conducted. The models mainly used for automatic composition using deep learning include recurrent neural networks and generative adversarial networks. Due to this research, the quality of automatically composed songs is also increasing. However, existing technologies, which include methods of automatically generating songs, disclose a simple structure of selling the automatically generated songs to general users or buyers.

In other words, the existing technologies only automatically generate songs and share or sell the generated songs. The research or disclosure has not been made regarding technologies that provide various services necessary for the automatic composition business.

### DISCLOSURE OF INVENTION

### Technical Problem

The object of the present invention is to propose a one-stop customized AI composition service where a music curator directly purchases deep learning models and learning data for song learning, trains the models, and generates and sells song data through the trained deep learning models.

However, the technical problems to be solved by the present invention are not limited to the above problems and vary within a range that does not depart from the technical idea and scope of the present invention.

### Solution to Problem

A system for a customized AI composition platform, according to an embodiment of the present invention, includes a music curator device that trains deep learning models to generate songs, and a platform server that provides deep learning models and learning data for automatic composition and collects the trained deep learning models and/or generated song data from at least one or more music curator devices to provide comprehensive services, wherein the music curator device transmits the deep learning models trained by the music curator or the song data generated by the trained deep learning models to an open market platform.

An operating method of a music curator device in a system for a customized AI composition platform, according to an embodiment of the present invention, includes the steps of: purchasing at least one deep learning model and learning data from among deep learning models and learning data for automatic composition provided by a platform server; training the deep learning model using the learning data to generate song data; and transmitting the trained deep learning model or the song data generated from the trained deep learning model to an open market platform.

### Effects of Invention

According to an embodiment of the present invention, by providing a one-stop customized AI composition service, anyone may generate songs with generative AI for composition, which lowers the barrier to entry for composition and brings various derivative effects to the user-generated content platform industry.

According to an embodiment of the present invention, songs of a style desired by an individual may be automatically generated using individually trained deep learning models, thereby improving user convenience in the automatic composition services.

According to an embodiment of the present invention, by generating unique song data through the process of individually training deep learning models or combining trained deep learning models to generate new deep learning models, various songs of various genres may be generated.

According to an embodiment of the present invention, by selling individually trained deep learning models and/or song data generated from trained deep learning models, profits for creative works may be generated.

However, the effects of the present invention are not limited to the above effects and vary within a range that does not depart from the technical idea and scope of the present invention.

### BRIEF DESCRIPTION OF THE DRAWINGS

FIG. 1 is a diagram illustrating the configuration of a system for a customized AI composition platform, according to an embodiment of the present invention.

FIG. 2 is a diagram illustrating the configurations of the devices shown in FIG. 1.

FIGS. 3 and 4 are diagrams illustrating examples of training deep learning models to generate song data, according to an embodiment of the present invention.

FIG. 5 is a flowchart illustrating an operating method of a music curator device in a system for a customized AI composition platform, according to an embodiment of the present invention.

### MODE FOR THE INVENTION

The advantages and features of the present invention and the methods of achieving the same may become clear with reference to the embodiments described in detail below with the accompanying drawings. However, the present invention is not limited to the embodiments disclosed below. The present invention may be implemented in various forms. The embodiments are provided only to ensure that the disclosure of the present invention is complete and to fully inform those skilled in the art of the scope of the invention. The present invention is defined only by the scope of the claims.

The terms used herein are for the purpose of describing the embodiments and are not intended to limit the present invention. The singular form herein includes the plural form unless specifically stated otherwise. As used herein, “comprises” and/or “comprising” do not preclude the presence or addition of one or more other components, steps, operations, and/or devices.

Unless defined otherwise, all terms used herein (including technical and scientific terms) may be used with the meanings that can be commonly understood by those skilled in the art. In addition, terms defined in commonly used dictionaries are not interpreted ideally or excessively unless explicitly defined otherwise.

Hereinafter, preferred embodiments of the present invention may be described in more detail with reference to the accompanying drawings. The same reference numerals are used for the same components in the drawings. Redundant descriptions for the same components are omitted.

The gist of the present invention is to provide a one-stop customized AI composition service where a music curator directly purchases deep learning models and learning data for song learning, trains the deep learning models, and generates and sells song data through the trained deep learning models.

The customized AI composition platform service, according to an embodiment of the present invention, provides not only deep learning models and learning data (copyrighted songs) for automatic composition but also various services necessary for the automatic composition business, such as model management/training/certification/sales.

The biggest advantage of the present invention is that a business operator (hereinafter referred to as a “music curator”), similar to a YouTuber, can generate and sell new song data by training the deep learning model purchased from a platform operator with learning data. The music curator who trains the deep learning model and generates and sells song data is a user of the one-stop customized AI composition service, according to an embodiment of the present invention.

In the present invention, the learning data and the song data are the same data related to composition, i.e., songs. The learning data may include data used to train the deep learning model and the song data may include data generated from the deep learning model.

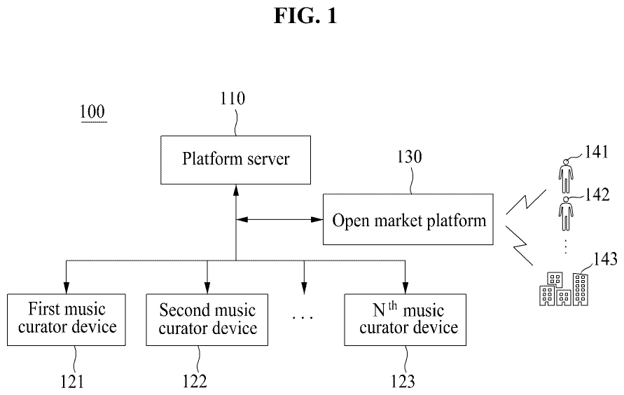

Hereinafter, the present invention may be described in detail with reference to FIGS. 1 to 5.

FIG. 1 is a diagram illustrating the configuration of a system for a customized AI composition platform, according to an embodiment of the present invention.

Referring to FIG. 1, a system for a customized AI composition platform 100 according to an embodiment of the present invention includes a platform server 110, a plurality of music curator devices 121 to 123, an open market platform 130, and a plurality of users 141 to 143. In other words, at least one or more music curator devices 121 to 123 may access the platform server 110 and receive deep learning models and learning data necessary for automatic composition from the platform server 110.

First, the platform server 110 wirelessly communicates with the plurality of music curator devices 121 to 123 to sell the deep learning models for automatic composition and the learning data for song learning. The platform server 110 manages, trains, authenticates, and sells the deep learning models to provide all the necessary services for the automatic composition business, allowing music curators to individually perform automatic composition. For example, the platform server 110 may provide basic information to the plurality of music curator devices 121 to 123. The basic information includes purchase and sales history information of the music curator's own learning data and models, purchase preference analysis information, current purchase preference information of other music curators' learning data and models, and information on frequently sold songs/models. This information may be provided to the plurality of music curator devices 121 to 123 in the form of text, figures, charts, and graphs, either for free or for a fee.

In addition, the platform server 110 may provide pre-trained deep learning models to music curator devices that connect to the platform server for the first time, i.e., novice music curators, to provide a program that helps the music curators become familiar with training. The pre-trained deep learning models may incur higher costs than scratch models.

Moreover, the platform server 110 may manage the open market platform 130. Although FIG. 1 shows the open market platform 130 as separate from the platform server 110, the open market platform 130 may be included in the platform server 110. Specifically, the models and songs registered and sold on the open market platform 130 may be provided by the platform server 110, and the platform server 110 may collect feedback from the plurality of users 141 to 143 on song data sold through the open market platform 130.

The open market platform 130 may provide song data registration, purchase, and payment services so that song data generated by the plurality of music curator devices 121 to 123 can be registered and purchased by the plurality of users 141 to 143. The open market platform 130 may provide a preview function for part of the song data being sold and an interest display function, such as “Like” or “Dislike.” When selling songs, the open market platform 130 may determine whether the learning data can be newly sold by determining whether the learning data is similar to the existing learning data or the learning data previously sold to the plurality of users 141 to 143. Only when it is determined that the learning data can be newly sold, the learning data may be sold to the plurality of users 141 to 143, including music curators. Accordingly, when the song data generated by a music curator has a high similarity to previously shared song data or learning data, the song data may not be sold.

In addition, the open market platform 130 may also provide deep learning model registration, purchase and payment services, by registering not only song data but also deep learning models trained by the plurality of music curator devices 121 to 123, so that the deep learning models can be purchased by the plurality of users 141 to 143. The open market platform 130 may authenticate and verify the deep learning models being sold. For example, the open market platform 130 may include online marketplaces, such as Smart Store, Coupang, Auction, Gmarket, SSG, 11th Street, Wemakeprice, Tmon, and Interpark, or social media platforms, such as YouTube and TikTok.

The plurality of users 141 to 143 may access the open market platform 130 and purchase song data generated by music curators to listen to, learn, and produce the same. The plurality of users 141 to 143 may be individual users or music curators, or even companies such as agencies. Accordingly, the individual users may access the open market platform 130 using their own devices, purchase and listen to song data. The music curators may access the open market platform 130 using their own devices, purchase song data, and use the same for training their purchased deep learning models. The agencies may access the open market platform 130 using devices within the company, purchase song data, and use the same for production. According to an embodiment, the individual users and music curators may follow other music curators and may preferentially access song data and deep learning models generated by the music curators they follow, compared to other music curators they do not follow on the open market platform 130.

The plurality of music curator devices 121 to 123, possessed by music curators who train deep learning models for automatic composition and generate songs using the trained deep learning models, may typically include smartphones, mobile phones, laptops, and tablet computing devices. As a portable wireless device which can be carried by a music curator and has wireless communication capabilities, each of the plurality of music curator devices 121 to 123 has a customized AI composition platform application installed, according to an embodiment of the present invention.

As the music curator carries the device and runs the customized AI composition platform application, each of the plurality of music curator devices 121 to 123 may connect to the platform server 110 and receive information necessary for automatic composition.

First, the music curator uses the device to run the customized AI composition platform application and then proceeds with the registration process to connect to the platform server 110. After the registration process, the music curator connects to the platform server 110, purchases an initial deep learning model for automatic composition, and purchase learning data for training the deep learning model. The learning data which is data for song learning may be copyrighted songs.

Afterward, the music curator trains the deep learning model using the purchased learning data and may generate song data using the trained deep learning model. The deep learning model may be a model of deep learning types, such as recurrent neural network (RNN), long short-term memory (LSTM), sequence-to-sequence (Seq2Seq), or generative pre-trained transformer (GPT). The size and selling price of the deep learning model may vary depending on the model.

The music curator may synthesize at least one or more trained deep learning models to generate a new deep learning model. The trained deep learning model may be a deep learning model directly trained by the music curator or a deep learning model trained by another music curator and purchased from the platform server 110 or the open market platform 130. In other words, the music curator may not only trade songs and models within the platform server 110 or the open market platform 130 but also generate completely new songs using the model generated by synthesizing multiple models. Such a platform service may produce many music curators, like YouTubers.

According to the configuration of the system for the customized AI composition platform 100 shown in FIG. 1, the platform server 110, music curators, the open market platform 130, and users may obtain various benefits and effects.

More specifically, the platform server 110 may generate profits by selling various types of scratch models or pre-trained deep learning models necessary for automatic composition. In addition, the platform server 110 may generate profits by selling copyrighted learning data and may receive fees for managing, training, or selling deep learning models. The platform server 110 may also receive fees for providing user feedback to music curators and providing various deep learning model synthesis functions.

The music curators may use the music curator device 120 to purchase deep learning models and copyrighted learning data necessary for automatic composition from the platform server 110, train the models using training functions provided by the platform server 110, and generate new song data from the trained models. In addition, the music curators may also purchase deep learning models trained by other music curators and synthesize the same with their own deep learning models, and purchase song data generated by other music curators to train their own deep learning models. When a good song is generated by training the deep learning models with the learning data, the music curator may upload and sell the same to the open market to generate profits. The music curators may also generate profits when users stream the generated song data.

The individual users may purchase and listen to songs sold or streamed by music curators and may use the purchased songs on other platforms (YouTube or TikTok) to generate profits.

The agencies may produce albums by producing songs purchased from the open market platform and may proceed with profitable production by receiving consumer preference information.

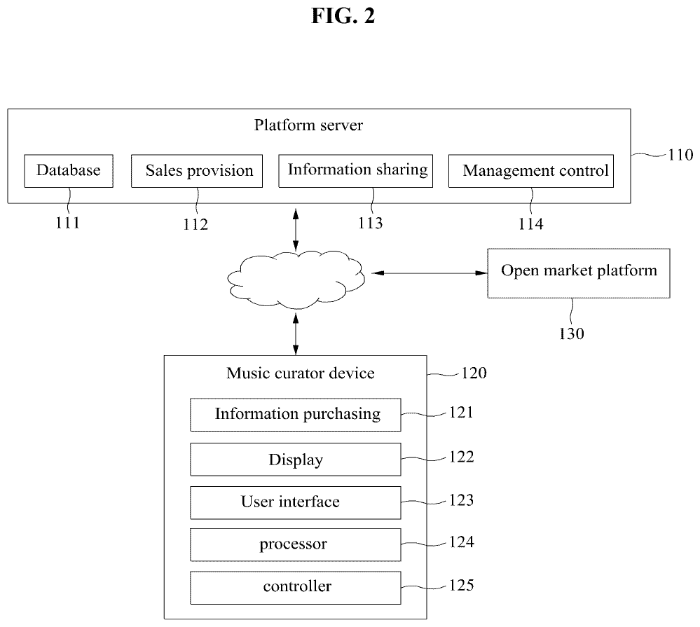

FIG. 2 is a diagram illustrating the configurations of the devices shown in FIG. 1.

Referring to FIG. 2, the platform server 110 provides comprehensive services by providing deep learning models and learning data for automatic composition and collecting trained deep learning models and/or generated song data from at least one of the music curator devices to.

To this end, the platform server 110 includes a database unit 111, a sales provision unit 112, an information sharing unit 113, and a management control unit 114.

The database unit 111 may store and maintain deep learning models and learning data. The database unit 111 includes deep learning models necessary for automatic composition, such as RNN, LSTM, Seq2Seq, and GPT, and may store and maintain learning data for training the deep learning models to generate songs. The database unit 111 may store and maintain, as learning data, not only initial data and initial models for automatic composition but also deep learning models trained by music curators and song data generated by using the trained deep learning models. For example, the database unit 111 may be linked with the open market platform 130 and may include song data and deep learning models sold on the open market platform 130.

The sales provision unit 112 may sell deep learning models and learning data. The sales provision unit 112 may sell deep learning models and learning data stored and maintained in the database unit 111 to a music curator device 120 upon request from the music curator device 120. The sales provision unit 112 may sell the deep learning models and learning data at predetermined prices according to the type, size, and number of deep learning models, the type and number of learning data, and whether the deep learning models have been pre-trained. In addition, the sales provision unit 112 may provide payment services.

For example, the sales provision unit 112 may determine whether the learning data can be newly sold by determining whether the learning data is similar to existing learning data and learning data previously sold to the music curator device 120. Only when it is determined that the learning data can be newly sold, the learning data may be sold to the music curator device 120.

The information sharing unit 113 may collect user feedback through the open market platform 130 to provide the user feedback to the music curator device 120.

The information sharing unit 113 may receive and manage user feedback on song data through the open market platform 130 to provide the user feedback to the music curator device 120 that generated the song data.

The management control unit 114 may authenticate and verify deep learning models. When a user purchases and streams song data through the open market platform 130, the management control unit 114 may provide the profits from the purchase and streaming of song data to the music curator device 120 that generated the song data. The management control unit 114 may provide predetermined profits to the music curator device 120 according to the type and amount of song data, wherein the profits may be in cash, cryptocurrency, or points.

In addition, the management control unit 114 includes a function to evaluate the quality of song data generated by the music curator device 120. The management control unit 114 may use this function to evaluate the quality of song data generated by the deep learning models trained by the music curator. As a result, the management control unit 114 may provide objective assistance in selling the song data generated by the music curator.

The management control unit 114 may guarantee the uniqueness, proof of ownership, and immutability of song data or trained deep learning models generated by each music curator device through non-fungible token (NFT).

The music curator device 120 trains deep learning models to generate songs and transmits the deep learning models trained by the music curator or song data generated from the trained deep learning models to the open market platform 130.

To this end, the music curator device 120 includes an information purchasing unit 121, a display 122, a user interface 123, a processor 124, and a controller 125.

The information purchasing unit 121 may purchase deep learning models for automatic composition and learning data for song learning from the platform server 110 through a wireless communication module.

According to the selection of the music curator received through the user interface 123, the information purchasing unit 121 may purchase at least one deep learning model among at least one or more types of deep learning models provided by the platform server 110 and at least one learning datum among at least one or more learning data for song learning. The deep learning model may be an initial model for automatic composition or a model trained by another music curator. In addition, the learning data may be initial data for automatic composition or song data generated by another music curator.

The display 122 may display a process screen for purchasing from the platform server and a process screen related to deep learning models and learning data. The display 122 may display, in the given space, at least one or more deep learning models sold by the platform server and at least one or more learning data classified according to song type, style, price, and quantity. The display 122 may display a user interface screen and may be implemented by at least one of a liquid crystal display, a thin film transistor-liquid crystal display, an organic light-emitting diode, a flexible display, and a three-dimensional (3D) display.

The user interface 123 receives the selection of the music curator. The user interface 123 has a function of receiving commands from the music curator for selecting deep learning models and learning data, training the deep learning models using the learning data, and generating new song data through the trained deep learning models. The user interface 123 may be implemented in the form of an integrated touch screen or monitor with the display 122.

The processor 124 may train deep learning models using learning data based on the selection of the music curator. Based on the selection of the music curator, the processor 124 may generate song data by training deep learning models according to the type, order, and amount of learning data purchased from the platform server 110 and song data of other music curators purchased from the open market platform 130. In other words, the processor 124 may train deep learning models using learning data purchased through the platform server 110 and the open market platform 130. The deep learning model may be an initial model for automatic composition or a model trained by another music curator. In addition, the learning data may be initial data for automatic composition or song data generated by another music curator.

For example, after training the deep learning model with new learning data, the processor 124 may roll back to the previous model based on the selection input of the music curator when the processor 124 fails to generate better song data than the model before training. However, since deep learning models take up a lot of capacity, the number of models that can be stored may be limited and the cost may increase as the number of stored models increases. In this case, the previous model may be stored for free by default.

The controller 125 may transmit the trained deep learning models or song data generated by the trained deep learning models to the open market platform 130 according to the processing results by the processor 124. The controller 125 may transmit the generated song data and trained deep learning models to the open market platform 130 so that at least one or more users accessing the open market platform 130 may purchase the song data.

In addition, the music curator may not only trade songs and models within the platform server 110 or the open market platform 130 but also generate completely new songs using the model generated by synthesizing multiple models. Accordingly, the controller 125 may synthesize at least one or more trained deep learning models to generate a new deep learning model and the processor 124 may train the new deep learning model with learning data to generate song data. The trained deep learning model may be a deep learning model directly trained by the music curator or a deep learning model trained by another music curator and purchased from the platform server 110 and the open market platform 130.

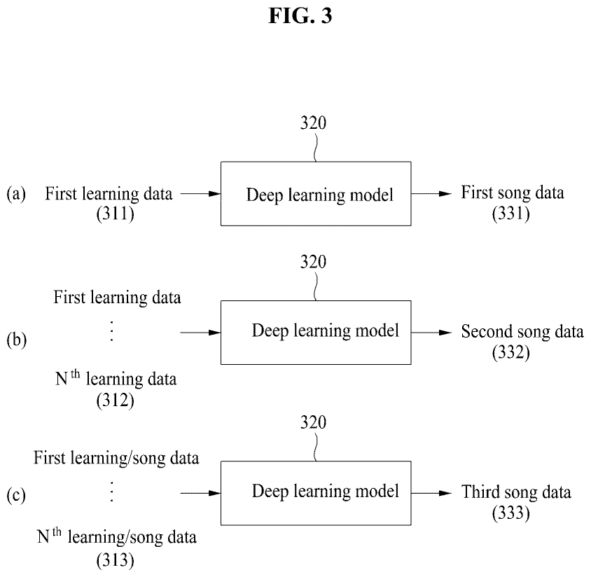

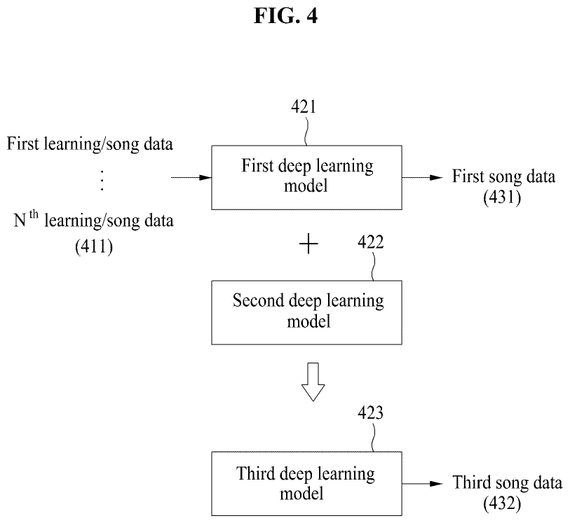

FIGS. 3 and 4 are diagrams illustrating examples of training deep learning models to generate song data, according to an embodiment of the present invention.

A system for a customized AI composition platform according to an embodiment of the present invention provides at least one deep learning model and at least one learning datum for training the deep learning model so that anyone can easily generate songs.

Accordingly, by purchasing deep learning models and learning data and training the deep learning models, music curators may generate their own song data through the trained deep learning models. As the type and quality of songs generated by the music curators from the deep learning models are determined by which learning data (e.g., genre or mood) is used, how much (e.g., number of training songs) and how (e.g., order of training songs) the deep learning models are trained, the composing ability of music curators may be determined.

Referring to FIG. 3, when a music curator trains a deep learning model 320 with learning data 311 of Korean traditional music, the deep learning model 320 generates song data 331 of Korean traditional music or song data 331 similar to Korean traditional music (see FIG. 3(a)). When the music curator trains the deep learning model 320 with at least one or more learning data 312 related to jazz, the deep learning model 320 generates song data 332 that is more specialized and closer to jazz than when trained with a single piece of learning data (see FIG. 3(b)). When the music curator trains the deep learning model 320 with at least one or more learning data related to K-pop and song data 313 related to K-pop generated by another music curator, the deep learning model 320 generates song data 333 related to K-pop from the data related to K-pop (see FIG. 3(c)). When training at least one or more learning data, the music curator may independently determine the order, type, amount, and training time of the learning data.

As such, since the type and style of the deep learning model are determined by how much, in what order, and how the music curator trained the learning data, the personal effort is important as the music curator must carefully manage his or her deep learning model to generate high-quality song data.

However, the type of learning data used to train the deep learning model can be an important factor. Accordingly, after training the deep learning model with new learning data, the system for the customized AI composition platform, according to an embodiment of the present invention, may roll back to the previous model based on the selection input of the music curator when the new learning data fails to generate better song data than the model before training. For example, after training a first-1 deep learning model to generate song data by adding learning data A to a first deep learning model, the music curator may select the rollback function if the song data has lower quality than the song data generated from the first deep learning model before training. Accordingly, the present invention may delete the first-1 deep learning model and revert the model to the first deep learning model.

In general, the more songs are trained, the higher the possibility of generating good songs. However, due to the characteristics of artificial neural networks, there is no standard method for generating good songs. Since the songs generated by the model also differ depending on the order in which multiple songs are trained, randomness also acts on deep learning models trained beyond a certain level.

As mentioned above, the trained deep learning models may be sold to other music curators as a product. The music curator may generate a new model by synthesizing at least one deep learning model trained by the music curator, synthesizing a deep learning model trained by the music curator and a deep learning model generated by another music curator, or synthesizing at least one deep learning model generated by another music curator. The new model thus generated may generate completely new genres and new songs by fusing the song generation information learned in each of the one or more models.

Referring to FIG. 4, it is assumed that a music curator trains a first deep learning model 421 with learning data 411 of Korean traditional music, and the trained first deep learning model 421 generates first song data 431 of Korean traditional music or first song data 431 similar to Korean traditional music. It is assumed that a second deep learning model 422 is trained with learning data of jazz and is trained by another music curator. Accordingly, the music curator may synthesize the first deep learning model 421 trained by the music curator with the purchased second deep learning model 422 to generate a new third deep learning model 423. The third deep learning model 423 is a combination of the learning information of the first deep learning model 421 trained with Korean traditional music and the learning information of the second deep learning model 422 trained with jazz. Accordingly, the music curator generates third song data 432, in which the genres of Korean traditional music and jazz are fused, through the third deep learning model 423. The model synthesis may refer to synthesis of the composition styles of the two trained models by synthesizing the parameters of the two models, wherein the synthesized models may continue to be trained.

As mentioned above, if a model synthesis history is formed, a specific model may form a value of hundreds of millions of Won. That is, if the model synthesis history is formed through the combination of models, the value of models located on the same line as the luxury line may increase. As a result, music curators may generate profits by selling song data generated from deep learning models managed by the music curators and may generate profits not only by selling song data but also by selling deep learning models. When entering the luxury line in the process of synthesizing multiple models, the music curators may gain additional fame and profits accordingly.

Since it is not possible to know how to train a deep learning model to generate good songs due to the characteristics of artificial neural networks, this may be a factor in determining the composing ability of the music curator, which can lead to the participation of users with composing ability.

Ultimately, it is not possible to explicitly know which model to select, which genre of song to train in which order and how to train the model to generate good songs, or which model to synthesize with which other models to generate good songs, but possible to know by experience, which can be the music curator's know-how and greatly affects the quality of the final composition. Thus, world-class music curators may be brought by being recognized for this talent. In addition, an inexperienced music curator may accidentally generate a very good song from a model trained with other data, which can encourage many people to participate as music curators, with a lottery-like luck.

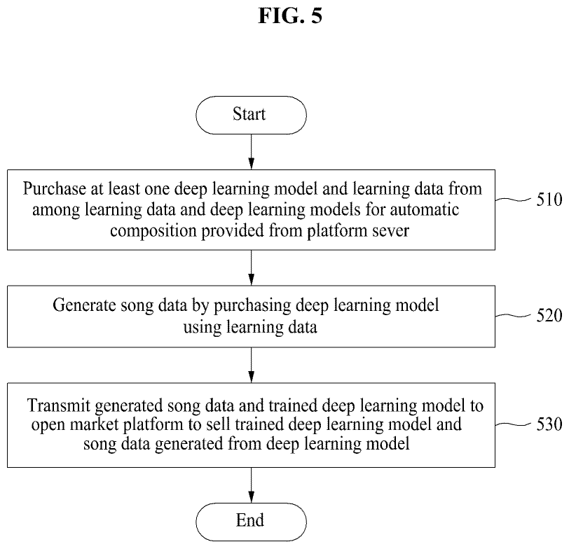

FIG. 5 is a flowchart illustrating an operating method of a music curator device in a system for a customized AI composition platform, according to an embodiment of the present invention.

Referring to FIG. 5, in step 510, a music curator device purchases at least one deep learning model and learning data among deep learning models and learning data for automatic composition provided by a platform server.

The music curator device may purchase at least one deep learning model among at least one or more types of deep learning models provided by the platform server and at least one learning datum among at least one or more learning data for song learning. The deep learning model may be an initial model for automatic composition or a model trained by another music curator. In addition, the learning data may be initial data for automatic composition or song data generated by another music curator.

In step 520, the music curator device trains the deep learning model using the learning data to generate song data.

Based on the selection of the music curator, the music curator device may train the deep learning model, according to the type, order, and amount of learning data purchased from the platform server and song data of other music curators purchased from the open market platform, to generate song data.

In step 530, the music curator device transmits the trained deep learning model or the song data generated by the trained deep learning model to the open market platform to sell the trained deep learning model or the generated song data.

Although the embodiments have been described by limited embodiments and drawings as shown above, various modifications and variations are possible from the above description by those skilled in the art. For example, appropriate results may be achieved even though the described technologies are performed in a different order than the described method, and/or the components of the described systems, structures, devices, or circuits are combined in a different form than the described method or are replaced or substituted by other components or equivalents.

Therefore, other implementations, other embodiments, and equivalents to the claims are also included in the scope of the claims below.

1. A system for customized AI composition platform, the system comprising:
a music curator device configured to generate a song by training a deep learning model; and
a platform server configured to provide comprehensive services by providing learning data and deep learning models for automatic composition and collecting trained deep learning models and/or generated song data from at least one or more music curator device,
wherein the music curator device transmits a deep learning model trained by a music curator or song data generated by the trained deep learning model to an open market platform.

2. The system of claim 1, wherein the music curator device comprises:
an information purchasing unit configured to purchase the deep learning model for automatic composition and the learning data for song learning from the platform server via a wireless communication module;
a display unit configured to display a process screen for purchase on the platform server and a process screen related to the deep learning model and the learning data;
a user interface configured to receive selection of the music curator;
a processor configured to train the deep learning model using the learning data based on the selection of the music curator; and
a controller configured to transmit the trained deep learning model or the song data generated from the trained deep learning model to the open market platform according to the processing result.

3. The system of claim 2, wherein the user interface receives the selection of the music curator, and the information purchasing unit, based on the selection of the music curator, purchases at least one deep learning model from among at least one or more types of deep learning models provided from the platform server and at least one learning datum for song learning from among at least one or more learning data.

4. The system of claim 2, wherein the processor, based on the selection of the music curator, generates the song data by training the deep learning model according to the type, order and amount of the learning data purchased from the platform server and the song data of another music curator purchased from the open market platform.

5. The system of claim 2, wherein the controller transmits the generated song data to the open market platform so that at least one user accessing the open market platform can purchase the song data.

6. The system of claim 2, wherein the controller generates a new deep learning model by synthesizing at least one or more trained deep learning models, and the processor trains the new deep learning model with the learning data.

7. The system of claim 1, wherein the platform server comprises:
a database unit that stores and maintains deep learning models and learning data;
a sales provision unit that sells deep learning models and learning data;
an information sharing unit that collects user feedback through the open market platform and provides the user feedback to the music curator device; and
a management control unit that authenticates and verifies deep learning models.

8. The system of claim 7, wherein the information sharing unit receives and manages user feedback on song data through the open market platform and provides the user feedback to the music curator.

9. The system of claim 7, wherein, when a user purchases and streams song data through the open market platform, the management control unit provides profits from purchase and streaming of the song data to the music curator.

10. An operating method of a music curator device in a system for a customized AI composition platform, the operating method comprising:
purchasing at least one deep learning model and learning data among deep learning models and learning data for automatic composition provided by a platform server,
training the deep learning model using the learning data to generate song data; and
transmitting the trained deep learning model or the song data generated by the trained deep learning model to an open market platform.
